(19) United States
(12) Patent Application Publication
(10) Pub. No.: US 2007/0288141 A1
(43) Pub. Date: Dec. 13, 2007

(54) Method and apparatus for visual odometry

(76) Inventors: James Russell Bergen, Hopewell, NJ (US); Oleg Naroditsky, Princeton, NJ (US); David Nister, Lexington, KY (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/159,968

(22) Filed: Jun. 22, 2005

Related U.S. Application Data
(60) Provisional application No. 60/581,867, filed on Jun. 22, 2004.

(51) Int. Cl. G01C 21/00

(52) U.S. Cl. 701/38; 701/200

(57) ABSTRACT

A method and apparatus for visual odometry (e.g., for navigating a surrounding environment) is disclosed. In one embodiment a sequence of scene imagery is received (e.g., from a video camera or a stereo head) that represents at least a portion of the surrounding environment. The sequence of scene imagery is processed (e.g., in accordance with video processing techniques) to derive an estimate of a pose relative to the surrounding environment. This estimate may be further supplemented with data from other sensors, such as a global positioning system or inertial or mechanical sensors.

### CROSS-REFERENCE TO RELATED APPLICATIONS

This application claims benefit of U.S. provisional patent application Ser. No. 60/581,867, filed Jun. 22, 2004, which is herein incorporated by reference in its entirety.

### REFERENCE TO GOVERNMENT FUNDING

The invention was made with Government support under grant number MDA972-01-9-0016 awarded by the Defense Advanced Research Projects Agency (DARPA). The Government has certain rights in this invention.

### BACKGROUND OF THE INVENTION

The utility of computer vision systems in a variety of applications is recognized. For example, autonomous navigation systems (e.g., for vehicles and robots) rely heavily on such systems for obstacle detection and navigation in surrounding environments. Such systems enable the navigation and/or surveillance of difficult or dangerous terrain without putting human operators at risk.

However, most existing systems for autonomous navigation lack versatility in that they are typically environment-specific. For example, GPS-based navigation systems work well in outdoor environments, but perform poorly indoors. Navigation systems that rely on information from wheel encoders work well when implemented in ground vehicles, but are unsuitable for use in, say, aerial vehicles. Moreover, most existing systems that operate by analyzing video or image data can provide knowledge of past motion, but cannot provide timely (e.g., real time) knowledge of current motion and/or position.

Therefore, there is a need in the art for a method and apparatus for visual odometry that is environment-independent and can reliably provide motion and/or position estimates in substantially real time.

### SUMMARY OF THE INVENTION

A method and apparatus for visual odometry (e.g., for navigating a surrounding environment) is disclosed. In one embodiment a sequence of scene imagery is received (e.g., from a video camera or a stereo head) that represents at least a portion of the surrounding environment. The sequence of scene imagery is processed (e.g., in accordance with video processing techniques) to derive an estimate of a pose relative to the surrounding environment. This estimate may be further supplemented with data from other sensors, such as a global positioning system or inertial or mechanical sensors.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram illustrating one embodiment of a method for visual odometry, according to the present invention;

FIG. 2 is a flow diagram illustrating one embodiment of a method for deriving motion and/or position estimates from video data, according to the present invention;

FIG. 3 is a flow diagram illustrating one embodiment of a method for point feature detection;

FIG. 4 is a flow diagram illustrating one embodiment of a method for point feature matching;

FIG. 5 is a flow diagram illustrating one embodiment of a method for generating a frame-to-frame incremental pose estimate, according to the present invention;

FIG. 6 is a flow diagram illustrating a second embodiment of a method for generating a frame-to-frame incremental pose estimate, according to the present invention;

FIG. 7 is a high level block diagram of the visual odometry method that is implemented using a general purpose computing device; and

FIG. 8 is an exemplary frame taken from a sequence of scene imagery, in which a plurality of point features is located by circles.

### DETAILED DESCRIPTION

The present invention discloses a method and apparatus for visual odometry (e.g., for autonomous navigation of moving objects such as autonomous vehicles or robots). Unlike conventional autonomous navigation systems, in one embodiment, the present invention relies primarily video data to derive estimates of object position and movement. Thus, autonomous navigation in accordance with the present invention is substantially environment-independent. Environment-specific sensors, such as those conventionally used in autonomous navigation systems, serve mainly as optional means for obtaining data to supplement a video-based estimate.

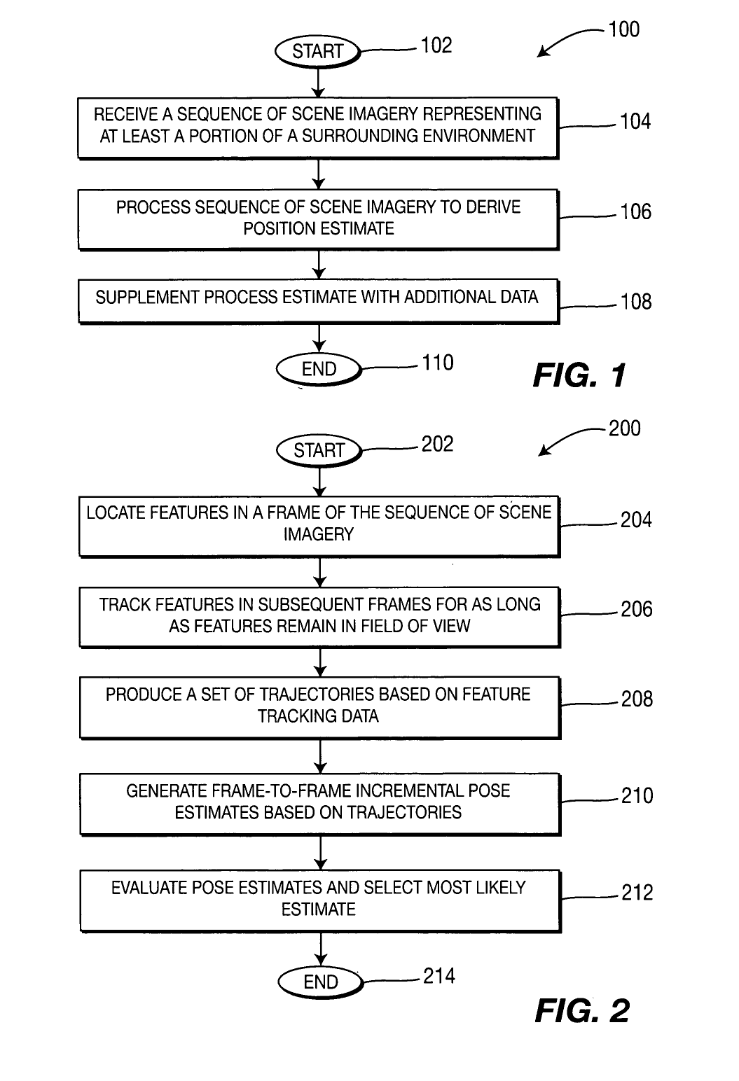

FIG. 1 is a flow diagram illustrating one embodiment of a method 100 for visual odometry, according to the present invention. The method 100 may be implemented in, for example, an object requiring navigation such as an autonomous (e.g., unmanned) vehicle or in a robot. The method 100 is initialized at step 102 and proceeds to step 104, where the method 100 receives a sequence of scene imagery representing at least a portion of a surrounding environment. In one embodiment, this sequence of scene imagery may be received via a moving camera or a stereo head mounted to the object requiring navigation.

In step 106, the method 100 processes the sequence of scene imagery to derive a position estimate therefrom. That is, the method 100 estimates a current position of the object requiring navigation directly from the received sequence of scene imagery. In one embodiment, the sequence of scene imagery is processed in accordance with any suitable known method for video processing.

Once a position estimate has been derived from the sequence of scene imagery, the method 100 optionally proceeds to step 108 and supplements the position estimate with additional data. Thus, in this embodiment, the video-based position estimate derived in step 106 may be considered a preliminary estimate that is subsequently refined by incorporating data from other sources. In one embodiment, this additional data includes data provided by at least one additional sensor, such as at least one of: a GPS system, inertial sensors and mechanical sensors (e.g., wheel encoders).

Once a position estimate has been derived (with or without the additional data), the method 100 terminates in step 110.

The method 100 thereby enables rapid, accurate motion and position estimation that is independent of the environment in which the method 100 functions. Because the method 100 relies primarily (and in some cases exclusively) on video data to derive motion and position estimates, it can be implemented to advantage in virtually any location: outdoors, indoors, on the ground, in the air, etc.

FIG. 2 is a flow diagram illustrating one embodiment of a method 200 for deriving motion and/or position estimates from video data, according to the present invention. The method 200 may be implemented in accordance with step 106 of the method 100, as discussed above, to produce a video-based estimate of the motion or position of a vehicle, robot or the like requiring navigation.

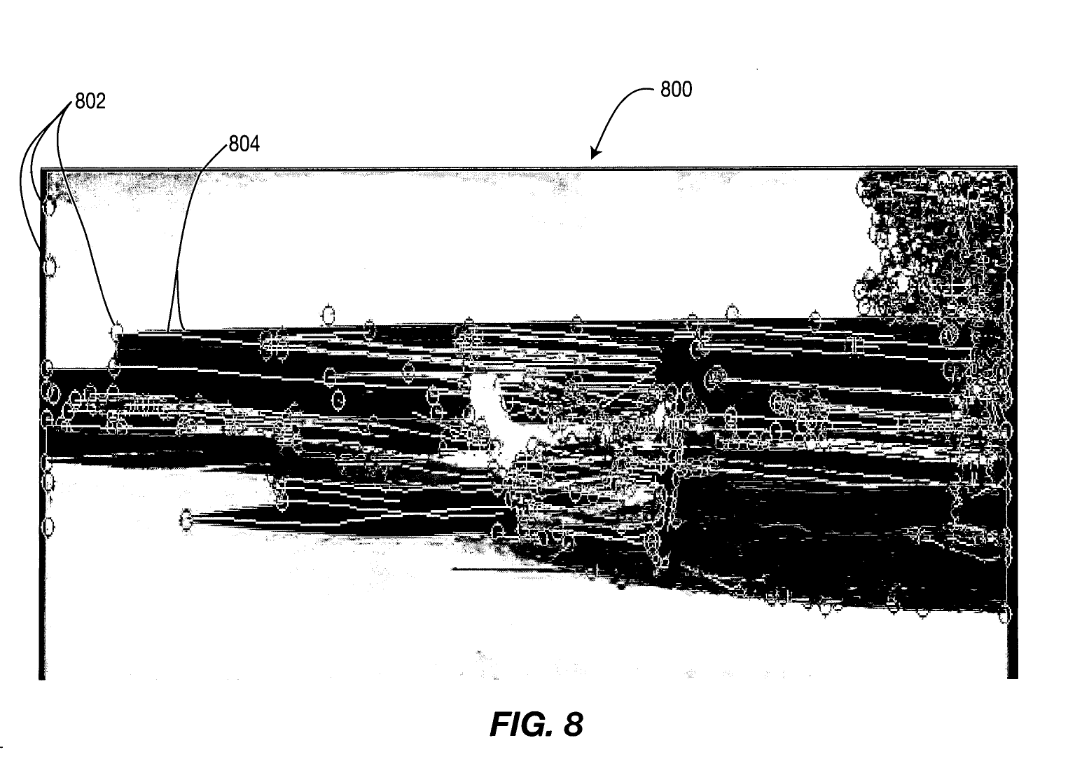

The method 200 is initialized at step 202 and proceeds to step 204, where the method 200 locates point features in a current frame of the sequence of scene imagery. In one embodiment, the located point features are features that are expected to remain relatively stable under small to moderate image distortions. For example, in one embodiment, the point features are Harris corners, as described by C. Harris and M. Stephens in A Combined Corner and Edge Detector (Proc. Fourth Alvey Vision Conference, pp. 147-151, 1988). Point features can be any identifiable element of the frame that can be reliably tracked. In one embodiment, up to hundreds of point features are located in step 202. For example, FIG. 8 is an exemplary frame 800 taken from a sequence of scene imagery, in which a plurality of point features is located by circles. For the sake of simplicity, only a handful of these circled point features have been labeled as 802.

In step 206, the method 200 tracks the point features located in step 204 over a plurality of subsequent frames (e.g., by matching the features to corresponding features in the subsequent frames). In one embodiment, the point features are tracked for as long as the features remain in the field of view. In one embodiment, tracking is performed without any geometric constraints.

In step 208, the method 200 produces a set of trajectories based on the feature tracking data obtained in step 206. The trajectories represent changes in the location and/or orientation of the tracked features relative to the object requiring navigation over time. In one embodiment, matched features are essentially linked between frames. Referring again to FIG. 8, a plurality of illustrated trajectories (a handful of which have been labeled as 804) indicates prior relative movement of associated point features.

Once the set of trajectories has been established, the method 200 proceeds to step 210 and generates a plurality of incremental frame-to-frame pose estimates for the vehicle, robot or the like that requires navigation, based on the information conveyed by the point feature trajectories. In one embodiment, “pose” is estimated with six degrees of freedom and is defined as three-dimensional (e.g., in x, y, z coordinates) location plus angular orientation. In one embodiment, pose estimates are generated in accordance with a geometric estimation method. Geometric estimation methods for generating pose estimates may vary depending on the means for capturing the original sequence of scene imagery (e.g., monocular video input, stereo input, etc.).

In step 212, the method 200 evaluates the pose estimates and selects the most likely estimate to be indicative of the current pose. In one embodiment, evaluation of pose estimates is performed in accordance with a known random sample consensus (RANSAC) technique (e.g., as discussed by D. Nister in Preemptive RANSAC for Live Structure and Motion Estimation, IEEE International Conference on Computer Vision, pp. 199-206, 2003), as discussed in greater detail below.

The method 200 terminates in step 214.

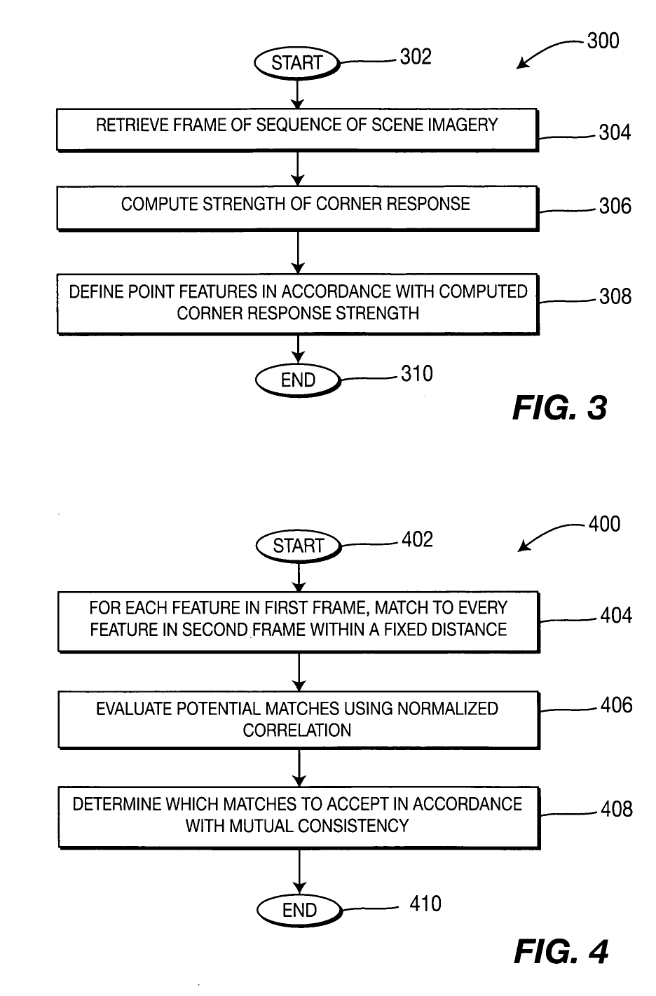

FIG. 3 is a flow diagram illustrating one embodiment of a method 300 for point feature detection, e.g., in accordance with step 204 of the method 200. The method 300 is initialized at step 302 and proceeds to step 304, where the method 300 retrieves an image frame from the sequence of scene imagery under analysis. In one embodiment, the image frame is represented with approximately eight bits per pixel.

In step 306, the method 300 computes the strength, s, of the frame's corner response. For example, in one embodiment a Harris corner detector computes the locally averaged moment matrix computed from the image gradients. The eigenvalues of the moment matrix are then combined to compute a corner response or “strength”, the maximum values of which indicate corner positions.

In one embodiment designed for very efficient computation (e.g., using a general purpose computer), s is computed as follows: for every output line of corner response, temporary filter outputs are needed for a certain number of lines above and below the current output line. All filter outputs are computed only once and stored in wrap-around buffers for optimal cache performance. The wrap-around buffers represent the temporary filter outputs in a rolling window. The rolling window contains the minimal number of lines necessary in order to avoid recomputing any filter outputs.

For example, in one embodiment, the horizontal and vertical derivatives of the image frame are represented as Iₓ and I_{y}, respectively. In one embodiment, Iₓ and I_{y} are computed by horizontal and vertical filters of the type [−1 0 1] and shifted down one bit before performing multiplications to keep the input down to eight bits and output down to sixteen bits.

In this case, the wrap-around buffers and resulting corner responses are updated line-by-line using four “sweeps” per line. The first sweep updates the wrap-around buffers for IₓIₓ, IₓI_{y} and I_{y}I_{y}. In one embodiment, the wrap-around buffers for IₓIₓ, IₓI_{y} and I_{y}I_{y} are fice lines long, and the typical sweep updates one line, positioned two lines ahead of the current output line of corner response.

The second sweep convolves all lines in the wrap-around buffers vertically with a binomial filter (e.g., [1 4 6 4 1]) in order to produce three single lines of thirty-tow-bit filter output: gₓₓ, g_{xy} and g_{yy}. In one embodiment, this is accomplished by shifts and additions to avoid expensive multiplications.

The third sweep convolves horizontally with the same binomial filter used in the second sweep to produce the thirty-two-bit single lines: Gₓₓ, G_{xy}, G_{xy}. Gₓₓ, G_{xy}, G_{xy} are stored back in the same place as gₓₓ, g_{xy} and g_{yy}, but are shifted two pixels.

Finally, the fourth sweep computes, in floating point:
the determinant, d=GₓₓG_{yy}−G_{xy}G_{xy} (EQN. 1)
the trace, t=Gₓₓ+G_{yy} (EQN. 2)
and the strength, s=d−kt² (EQN. 3)
of the corner response (where k=0.06). In one embodiment, the first through fourth sweeps are all implemented in multimedia extension (MMX) chunks of 128 pixels and interleaved manually to avoid stalls and to make optimal use of both pipelines.

Referring back to FIG. 3, once the strength of the corner response has been computed, the method 300 proceeds to step 310 and defines point features in the image frame in accordance with the computed corner response strength. As described above, as many as several hundred point features may be defined in a single image frame. In one embodiment, definition of point features is achieved in accordance with a non-maximum suppression technique. Specifically, a point feature is declared at each pixel where the corner response is computed to be stronger than at all other pixels within a defined radius (e.g., a five-pixel-by-five-pixel neighborhood).

The method 300 terminates in step 312.

FIG. 4 is a flow diagram illustrating one embodiment of a method 400 for point feature matching, e.g., in accordance with step 206. The method 400 is initialized at step 402 and proceeds to step 404, where the method 400 attempts to match a given point feature in a first frame to every point feature within a fixed distance from a corresponding point feature in a second frame (e.g., all point features within a predefined disparity limit from each other are matched). In one embodiment, a disparity limit for point feature matching is approximately three to thirty percent of the image size, depending on the desired output speed and the smoothness of the input sequence of scene imagery.

The next phase of the method 400 establishes frame-to-frame feature correspondence. This frame-to-frame feature correspondence can be established in accordance with a variety of known methods, including optical flow and area correlation techniques. Steps 406-408 illustrate one exemplary process for establishing frame-to-frame feature correspondence, which is optimized for speed of computation (e.g., on a general purpose computer).

In step 406, the method 400 evaluates potential point feature matches between the first and second frame using normalized correlation. In one embodiment, normalized correlation is performed over an eleven-pixel-by-eleven-pixel window centered on the detected point feature. In one embodiment, uniform weighting is used across the whole window for speed. Each window is copied from the image frame and laid out consecutively in memory as an n=121 byte vector (in one embodiment padded to 128 bytes for convenience). For each window, the following values are pre-computed:

$$\begin{matrix}A = Σ I & ( EQN . 4 ) \\ B = Σ {I}^{2} & ( EQN . 5 ) \\ C = \frac{1}{\sqrt{nB - {A}^{2}}} & ( EQN . 6 )\end{matrix}$$

Then, for each potential match, the following scalar product is computed between the two windows:
D=Σ I₁I₂ (EQN. 7)

The normalized correlation is then:
(nD−A₁A₂)C₁C₂ (EQN. 8)

Once the normalized correlations are computed for each potential match, the method 400 proceeds to step 408 and determines which matches to accept, in accordance with mutual consistency. In accordance with this theory, every point feature in the first image frame is involved in a number of normalized correlations with point features from the second image frame (e.g., as determined by the maximum disparity). The point feature from the second image frame that produces the highest normalized correlation is thus selected as the preferred match to the point feature in the first frame. Conversely, each point feature in the second image frame will also generate a preferred match in the first image frame. Accordingly, pairs of point features that mutually designate each other as the preferred match are accepted as valid matches. As described above, this matching technique may be performed over a plurality of image frames in order to generate a trajectory that illustrates the motion of a point feature over time.

The method 400 terminates in step 410.

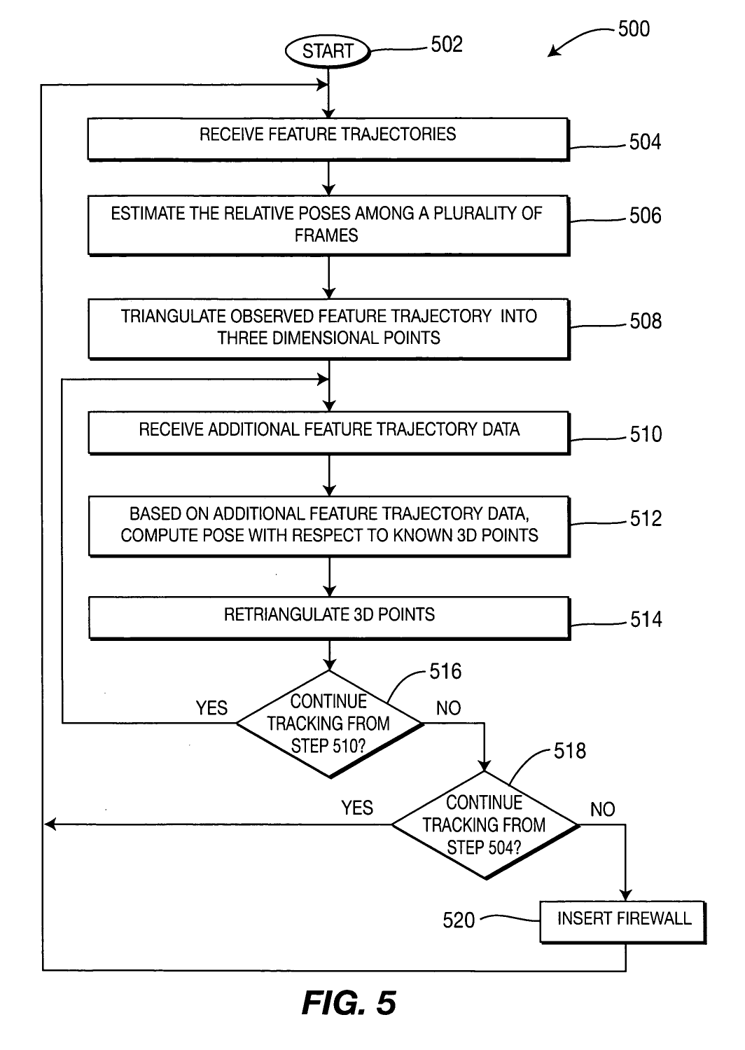

FIG. 5 is a flow diagram illustrating one embodiment of a method 500 for generating a frame-to-frame incremental pose estimate, according to the present invention. Those skilled in the art will appreciate that any one of a variety of known frame-to-frame pose estimation methods may be implemented to generate the estimate, and the method 500 is only one exemplary method that may be used. The method 500 is especially well-suited for real-time frame-to-frame pose estimation in environments that may contain moving objects or other potential sources of image correspondences that do not correspond to camera motion.

The method 500 may be implemented, for example, in accordance with step 210 of the method 200 discussed above. In particular, the method 500 is useful in generating frame-to-frame incremental pose estimates based on monocular video input (e.g., data from a single moving video camera).

The method 500 is initialized at step 502 and proceeds to step 504, where the method 500 receives a plurality of point feature trajectories for point features tracked through a plurality of frames of the sequence of scene imagery (e.g., received as a feed from a single video camera mounted to a moving object requiring navigation). In step 506, the method 500 estimates, based on the received trajectory data, the poses of the object requiring navigation relative to the identified point features from among the plurality of frames.

In one embodiment, pose estimation in accordance with step 506 is performed in accordance with a five-point algorithm (e.g., as described in U.S. patent application Ser. No. 10/798,726, filed Mar. 11, 2004, which is herein incorporated by reference in its entirety) and pre-emptive RANSAC, followed by an iterative refinement. Thus, the method 500 generates a set of possible pose solutions or hypotheses based on the provided point features. These hypotheses are generated by selecting a subset of the available point feature trajectories. In one embodiment, this subset includes at least five randomly selected point feature trajectories. Each of these hypotheses is then evaluated against all available point feature trajectories to determine which hypothesis is consistent with the maximum number of feature trajectories. In one embodiment, this maximally consistent hypothesis is taken to be the most likely to be correct.

In step 508, the method 500 uses the estimated pose determined in step 506 to triangulate the observed point feature trajectories into a plurality of three-dimensional (3D) points. In one embodiment, triangulation is performed using the first and last observed point features along the point feature trajectory. In further embodiments, triangulation is performed in accordance with optimal triangulation according to directional error. In one embodiment, if it is not the first time that step 508 is being executed, a scale factor between the present point feature trajectory results and an immediately previous point feature trajectory result is estimated (e.g., in accordance with a preemptive RANSAC procedure). The present point feature trajectory results then replace the previous results.

In step 510, the method 500 receives additional point feature trajectory data, e.g., in the form of a stream of video input as the associated point features are tracked for a number of subsequent frames (e.g., subsequent to the point at which the point feature trajectories were first received in step 504). In step 512, the method 500 computes, based on the additional point feature trajectory data, the current pose with respect to the known 3D points (e.g., as established in step 508). In one embodiment, pose estimation is performed in accordance with a three-point, two-dimensional-to-three-dimensional algorithm and pre-emptive RANSAC, followed by an iterative refinement. One known three-point algorithm (described, for example, by R. Haralick, C. Lee, K. Ottenberg and M. Nolle in Review and Analysis of Solutions of the Three Point Perspective Pose Estimation Problem, International Journal of Computer Vision, 13(3):331-356, 1994, and by various textbooks) uses the correspondence of three two-dimensional image points to three three-dimensional world points to estimate the camera pose.

Following pose estimation with respect to the known three-dimensional points in step 512, the method 500 proceeds to step 514 and re-triangulates additional 3D points with relation to the new point feature trajectory data. In one embodiment, re-triangulation is performed using the first and last observed feature points along the trajectory (e.g., which now includes the new feature point trajectory data). The method 500 then proceeds to step 516 and determines whether tracking should be continued (e.g., whether additional point feature trajectory data should be processed) from step 510. In one embodiment, the determination as to whether to continue with further iterations from step 510 may be made in accordance with any one or more of a number of application-specific criteria, such as at least one of: computational cost and environmental complexity. For example, the three-point pose estimation technique discussed above is generally less computationally complex than other related methods, so performing additional three-point estimates relative to the number of five-point estimates will typically decrease overall computational load. However, the accuracy of the three-point pose estimation technique depends directly on the accuracy of the triangulated three-dimensional points, which may be subject to errors, especially in complex scene environments. Thus, balancing these considerations on an application-by-application method id generally desirable to determine the optimal number of iterations of steps 510-514 for a given application. In one embodiment, however, the number of iterations from step 510 is pre-set to three.

If the method 500 determines in step 516 that tracking should be continued from step 510, the method 500 returns to step 510 and proceeds as described above. Alternatively, if the method 500 determines in step 516 that tracking should not be continued from step 510, the method 500 proceeds to step 518.

In step 518, the method 500 determines whether tracking should be continued (e.g., whether additional feature trajectory data should be processed) from step 504. In one embodiment, processing continues from step 504 for a number of iterations, where the number of iterations depends on application-specific criteria such as the motion speed and probability of pose and/or triangulation errors. In one embodiment, the number of iterations performed from step 504 is pre-set to three. If the method 500 determines in step 518 that tracking should be continued from step 504, the method 500 returns to step 504 and proceeds as described above. Alternatively, if the method 500 determines in step 518 that tracking should not be continued from step 504, the method 500 proceeds to step 520.

In step 520, the method 500 inserts a firewall into the stream of input data such that future triangulations of 3D points will not be performed using observations that precede the most recent firewall. Thus, for the purposes of triangulation, the frame of the sequence of scene imagery immediately following the firewall is considered the first frame. In other words, the three-dimensional points used for preceding iterations are discarded and a completely new set of three-dimensional points is estimated. This helps to reduce the propagation of errors (e.g., in 3D points positioning, pose estimation, etc.) throughout execution of the method 500. The method 500 then returns to step 504 and proceeds as described above.

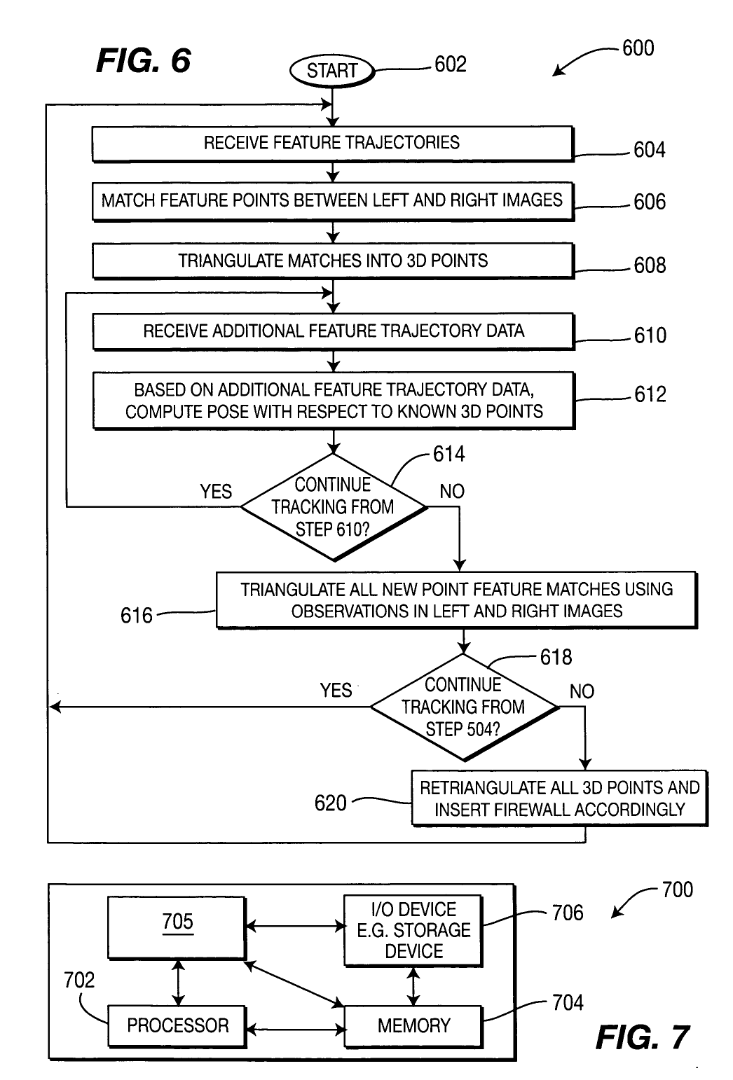

FIG. 6 is a flow diagram illustrating a second embodiment of a method 600 for generating a frame-to-frame incremental pose estimate, according to the present invention. Like the method 500, the method 600 may be implemented in accordance with step 210 of the method 200 discussed above. However, in contrast to the method 500, the method 600 is useful in generating frame-to-frame incremental pose estimates based on stereo video (e.g., data from a calibrated pair of video cameras).

The method 600 is initialized at step 602 and proceeds to step 604, where the method 600 receives point feature trajectories (e.g., as embodied in individual feeds from two moving video cameras mounted to a moving vehicle or robot). The point feature trajectories are received from two different views that present different perspectives of the same point feature trajectories (e.g., as viewed from a left video camera and a right video camera). The method 600 then proceeds to step 606 and matches point features between the two views as presented in incoming images or sequences of scene imagery.

In step 608, the method 600 triangulates the matches established in step 606 into 3D points using knowledge of stereo calibration data. Additional point feature trajectory data is then received in step 610.

In step 612, the method 600 estimates, based on the received point feature trajectory data, the relative poses of the object requiring navigation (e.g., upon which the stereo head is mounted) among a plurality of frames of the sequences of scene imagery. In one embodiment, pose estimation in accordance with step 612 is performed in accordance with a three-point algorithm (e.g., as discussed above, using features from, for example, the left images) and pre-emptive RANSAC, followed by an iterative refinement based on features in both the left and right images. Thus, the method 600 generates a set of possible pose solutions or hypotheses based on the provided feature points. These hypotheses are generated by selecting a subset of the available feature trajectories. In one embodiment, this subset includes at least three randomly selected feature trajectories. Each of these hypotheses is then evaluated against all available feature trajectories to determine which hypothesis is the most likely to be correct (e.g., based on maximal consistency with all features).

In step 614, the method 600 determines whether tracking should be continued (e.g., whether additional point feature trajectory data should be processed) from step 610. As discussed above, this determination may be made based on application-specific criteria, or iterations may be performed a fixed number of times. If the method 600 determines in step 614 that tracking should be continued from step 610, the method 600 returns to step 610 and proceeds as described above. Alternatively, if the method 600 determines in step 614 that tracking should not be continued from step 610, the method 600 proceeds to step 616.

In step 616, the method 600 triangulates all new point feature matches in accordance with observations in the left and right images. The method 600 then proceeds to step 618 and determines whether tracking should be continued from step 610. As discussed above, this determination may be made based on application-specific criteria, or iterations may be performed a fixed number of times. If the method 600 determines in step 618 that tracking should be continued from step 610, the method 600 returns to step 610 and proceeds as described above. Alternatively, if the method 600 determines in step 618 that tracking should not be continued from step 610, the method 600 proceeds to step 620.

In step 620, the method 600 discards all existing 3D points and re-triangulates all 3D points based on the new point feature trajectory data and accordingly inserts a firewall into the stream of input data such that future triangulations of 3D points will not be performed using observations that precede the most recent firewall. The method 600 then returns to step 610 and proceeds as described above.

FIG. 7 is a high level block diagram of the visual odometry method that is implemented using a general purpose computing device 700. In one embodiment, a general purpose computing device 700 comprises a processor 702, a memory 704, a visual odometry module 705 and various input/output (I/O) devices 706 such as a display, a keyboard, a mouse, a modem, and the like. In one embodiment, at least one I/O device is a storage device (e.g., a disk drive, an optical disk drive, a floppy disk drive). It should be understood that the visual odometry module 705 can be implemented as a physical device or subsystem that is coupled to a processor through a communication channel.

Alternatively, the visual odometry module 705 can be represented by one or more software applications (or even a combination of software and hardware, e.g., using Application Specific Integrated Circuits (ASIC)), where the software is loaded from a storage medium (e.g., I/O devices 706) and operated by the processor 702 in the memory 704 of the general purpose computing device 700. Thus, in one embodiment, the visual odometry module 705 for estimating motion and position described herein with reference to the preceding Figures can be stored on a computer readable medium or carrier (e.g., RAM, magnetic or optical drive or diskette, and the like).

In further embodiments, the present invention can be implemented in an integrated sensing device that combines visual odometry with conventional navigation devices (such as GPS, inertial measurement units, compasses and the like). In such embodiments, the six degrees of freedom motion estimates produced by visual odometry are used to correct estimates produced by conventional sensors, or vice versa. This integrated system can thus produce a single navigation solution incorporating all available sensor inputs. An advantage of such a system over conventional devices is that an integrated navigation system can operate either on visual input alone or on visual input supplemented with additional sensor input for more accurate and stable localization.

Thus, the present invention represents a significant advancement in the field of autonomous navigation. A method and apparatus are provided that enable a moving object (e.g., an autonomous vehicle or robot) to navigate a surrounding environment regardless of the nature of the surrounding environment. By processing primarily video data, which is obtainable in substantially any environment or conditions, location and movement can be accurately estimated. Data from additional, environment-specific sensors, such as those conventionally used in autonomous navigation systems, may then be optionally used to supplement estimates derived from the video data.

While the foregoing is directed to embodiments of the present invention, other and further embodiments of the invention may be devised without departing from the basic scope thereof, and the scope thereof is determined by the claims that follow.

1. A method for navigating a surrounding environment, comprising:
receiving a sequence of scene imagery representing at least a portion of said surrounding environment; and
processing said sequence of scene imagery to derive an estimate of a pose relative to said surrounding environment.

2. The method of claim 1, further comprising:
receiving supplemental position-related data from at least one sensor; and
supplementing said estimate with said supplemental position-related data.

3. The method of claim 2, wherein said at least one sensor is at least one of: a global positioning system, an inertial sensor and a mechanical sensor.

4. The method of claim 1, wherein said pose comprises:
a three-dimensional location; and
an angular orientation.

5. The method of claim 1, wherein said processing comprises:
locating a plurality of point features in a first frame of said sequence of scene imagery;
tracking said plurality of point features over a plurality of subsequent frames of said sequence of scene imagery to generate a first plurality of associated point feature trajectories; and
estimating said pose in accordance with said first plurality of point feature trajectories.

6. The method of claim 5, wherein said locating comprises:
computing a corner response for each pixel in said first frame of said sequence of scene imagery; and
declaring a point feature at each pixel for which said corner response is stronger than at all other pixels within a defined radius.

7. The method of claim 5, wherein said tracking comprises:
comparing each of said plurality of point features in said first frame of said sequence of scene imagery against a second plurality of point features in at least one subsequent frame of said sequence of scene imagery to generate a plurality of potential matches; and
selecting one of said potential matches in accordance with mutual consistency.

8. The method of claim 7, wherein said second plurality of point features comprises every point feature in said subsequent frame that is within a predefined distance from a point feature that corresponds to a given point feature in said first frame.

9. The method of claim 5, wherein said estimating comprises:
generating a plurality of frame-to-frame incremental pose estimates based on designated subsets of said first plurality of point feature trajectories; and
selecting one of said plurality of frame-to-frame incremental pose estimates as being most likely to be indicative of said pose.

10. The method of claim 9, wherein said generating comprises:
receiving two simultaneous stereo views of said first plurality of point feature trajectories;
triangulating a plurality of three-dimensional points in accordance with said two simultaneous stereo views;
receiving subsequent point feature trajectory data associated with said plurality of three-dimensional points; and
generating at least one incremental pose estimate in accordance with said plurality of three-dimensional points and said first plurality of point feature trajectories.

11. The method of claim 5, further comprising:
incrementally triangulating a second plurality of point feature trajectories to a plurality of three-dimensional points;
receiving subsequent point feature trajectory data associated with said second plurality of point feature trajectories; and
generating at least one incremental pose estimate in accordance with said plurality of three-dimensional points and said second plurality of point feature trajectories.

12. A computer-readable medium having stored thereon a plurality of instructions, the plurality of instructions including instructions which, when executed by a processor, cause the processor to perform the steps of a method for navigating a surrounding environment, comprising:
receiving a sequence of scene imagery representing at least a portion of said surrounding environment; and
processing said sequence of scene imagery to derive an estimate of a pose relative to said surrounding environment.

13. The computer-readable medium of claim 12, further comprising:
receiving supplemental position-related data from at least one sensor; and
supplementing said estimate with said supplemental position-related data.

14. The computer-readable medium of claim 13, wherein said at least one sensor is at least one of: a global positioning system, an inertial sensor and a mechanical sensor.

15. The computer-readable medium of claim 12, wherein said pose comprises:
a three-dimensional location; and
an angular orientation.

16. The computer-readable medium of claim 12, wherein said processing comprises:
locating a plurality of point features in a first frame of said sequence of scene imagery;
tracking said plurality of point features over a plurality of subsequent frames of said sequence of scene imagery to generate a first plurality of associated point feature trajectories; and
estimating said pose in accordance with said first plurality of point feature trajectories.

17. The computer-readable medium of claim 16, wherein said locating comprises:
computing a corner response for each pixel in said first frame of said sequence of scene imagery; and
declaring a point feature at each pixel for which said corner response is stronger than at all other pixels within a defined radius.

18. The computer-readable medium of claim 16, wherein said tracking comprises:
comparing each of said plurality of point features in said first frame of said sequence of scene imagery against a second plurality of point features in at least one subsequent frame of said sequence of scene imagery to generate a plurality of potential matches; and
selecting one of said potential matches in accordance with mutual consistency.

19. The computer-readable medium of claim 18, wherein said second plurality of point features comprises every point feature in said subsequent frame that is within a predefined distance from a point feature that corresponds to a given point feature in said first frame.

20. The computer-readable medium of claim 16, wherein said estimating comprises:
generating a plurality of frame-to-frame incremental pose estimates based on designated subsets of said first plurality of point feature trajectories; and
selecting one of said plurality of frame-to-frame incremental pose estimates as being most likely to be indicative of said pose.

21. The computer-readable medium of claim 20, wherein said generating comprises:
receiving two simultaneous stereo views of said first plurality of point feature trajectories;
triangulating a plurality of three-dimensional points in accordance with said two simultaneous stereo views;
receiving subsequent point feature trajectory data associated with said plurality of three-dimensional points; and
generating at least one incremental pose estimate in accordance with said plurality of three-dimensional points and said first plurality of point feature trajectories.

22. The computer-readable medium of claim 16, further comprising:
incrementally triangulating a second plurality of point feature trajectories to a plurality of three-dimensional points;
receiving subsequent point feature trajectory data associated with said second plurality of point feature trajectories; and
generating at least one incremental pose estimate in accordance with said plurality of three-dimensional points and said second plurality of point feature trajectories.

23. An apparatus for navigating a surrounding environment, comprising:
means for receiving a sequence of scene imagery representing at least a portion of said surrounding environment; and
means for processing said sequence of scene imagery to derive an estimate of a pose relative to said surrounding environment.
